(19) United States
(12) Patent Application Publication
(10) Pub. No.: US 2009/0171776 A1
(43) Pub. Date: Jul. 2, 2009

(54) SYSTEM AND METHOD FOR PROVIDING VARIABLE INCENTIVES BASED ON SPENDING

(75) Inventor: German Scipioni, San Jose, CA (US)

Correspondence Address: Haynes and Boone, LLP;IP Section, 2323 Victory Avenue, SUITE 700, Dallas, TX, 75219, US

(73) Assignee: eBay Inc.

(21) Appl. No.: 11/966,670

(22) Filed: Dec. 28, 2007

(51) Int. Cl. G06Q 30/00; G06Q 40/00

(52) U.S. Cl. 705/14; 705/35; 705/39

(57) ABSTRACT

Systems and methods for providing incentives to a customer based on spending behavior include a customer account established with the customer for depositing funds and for purchasing one or more items from at least one merchant. A first rate of return is applied to the deposited funds in the customer account based on the amount of funds spent from the customer account. A second rate of return is applied to funds in the customer account based on the amount of funds not spent from the customer account. The first rate of return is at least greater than the second rate of return, and the first and second rates of return comprise an interest rate.

### BACKGROUND

1. Field of the Invention

The present invention generally relates to financial transactions and more particularly to providing variable incentives to a customer based on spending behavior.

2. Related Art

During the course of financial transactions, customers provide payment in exchange for items from a merchant. Payment options include, for example, checks, debit cards, credit cards, and electronic fund transfers.

Presently, some financial institutions offer dividends (i.e., cash back rewards) for items purchased with a specific payment option, such as a credit card. However, this type of reward is typically limited to revolving credit accounts and does not apply to checking accounts having debit cards linked thereto. Financial institutions, such as banks, that provide checking account services and linked debit cards only offer a low interest rate on money deposited in the checking accounts. Typically, banks do not offer any type of reward for spending money from a checking account. In many instances, banks charge customers a fee for using the debit card when making purchases.

Thus, there currently exists a need to improve the process of purchasing goods, products and/or services in financial transactions that benefits the customer.

### SUMMARY

In accordance with embodiments of the invention, systems and methods for providing incentives to a customer based on spending behavior include a customer account established with the customer for depositing funds and for purchasing one or more items. A first rate of return is applied to the deposited funds in the customer account based on the amount of funds spent from the customer account, and a second rate of return is applied to funds in the customer account based on the amount of funds not spent from the customer account.

In various implementations, the first rate of return is at least greater than the second rate of return, and the first and second rates of return comprise an interest rate with an annual percentage yield (APY) or a dividend that pays back a percentage of the purchase costs to the customer. The customer account comprises a checking account.

In accordance with embodiments of the invention, systems and methods for providing incentives to a customer based on one or more financial transactions between the customer and at least one merchant. The systems and methods include a transaction service provider adapted to establish a customer account with the customer for depositing funds and for purchasing one or more items from the at least one merchant. The transaction service provider is adapted to apply a first rate of return to funds in the customer account based on the amount of funds spent from the customer account, and the transaction service provider is adapted to apply a second rate of return to funds in the customer account based on the amount of funds not spent from the customer account.

In accordance with embodiments of the invention, systems and methods for providing incentives to a customer based on spending behavior include establishing a customer account with a customer for depositing funds and for purchasing one or more items from the at least one merchant. The systems and methods include monitoring the spending behavior of the customer and applying a first rate of return to the deposited funds based on the amount of funds spent from the customer account and applying a second rate of return to the deposited funds based on the amount of funds not spent from the customer account.

In various implementations, the systems and methods include processing financial transactions between the customer and at least one merchant. The systems and methods include maintaining a plurality of accounts including the customer account and a merchant account related to the merchant.

These and other features and advantages of the present invention will be more readily apparent from the detailed description of the embodiments set forth below taken in conjunction with the accompanying drawings.

### BRIEF DESCRIPTION OF THE FIGURES

FIGS. 1A-1C show block diagrams of various systems for facilitating financial transactions in accordance with embodiments of the invention.

FIGS. 2-5 show block diagrams of various methods for providing incentives to a customer based on spending behavior in accordance with embodiments of the invention.

FIG. 6 shows a block diagram of a computer system suitable for implementing embodiments of the invention.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure enable a financial service provider to variably and/or selectively assign a rate of return to a customer account based on the spending behavior of the customer. In one implementation, the rate of return on an investment is adjusted to influence the customer to maintain a higher balance in the account. For example, a loyal customer (i.e., a customer having a high rate of spending) may be given a higher rate of return in interest and/or dividend as a reward for keeping money in the account (i.e., maintaining a higher balance in the account). The financial service provider provides an incentive to the customer to spend money deposited in an account that is established with the financial service provider. In this way, the financial service provider may vary the rate of return applied to the customer account based on the amount of money spent by the customer in a specified period of time, such as a month.

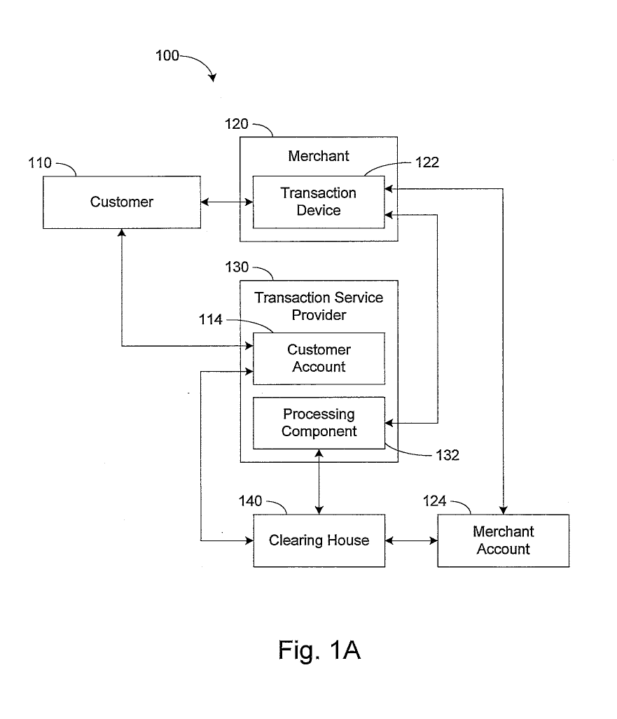

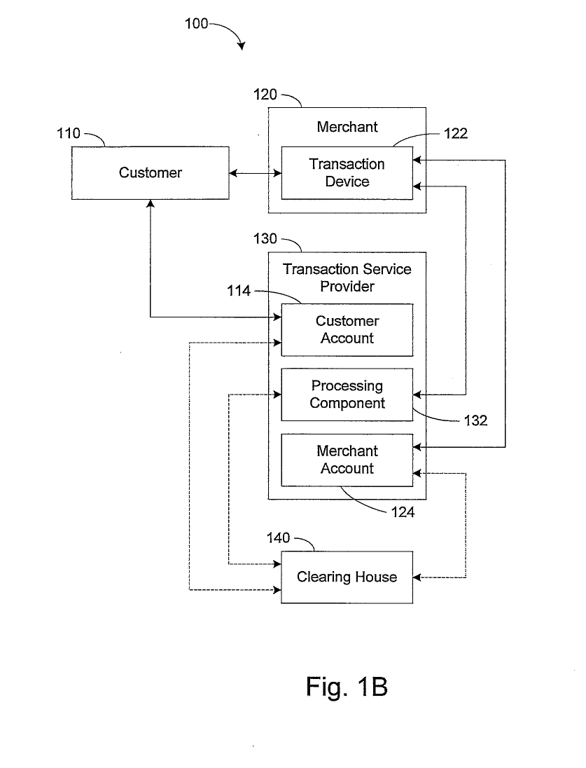

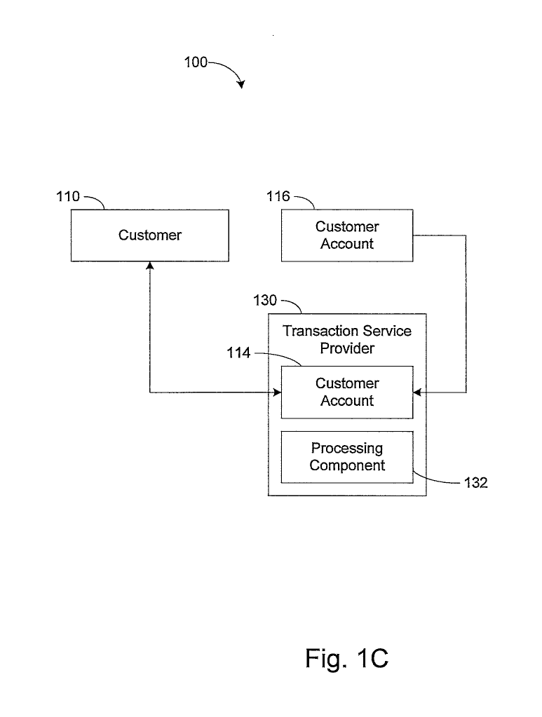

FIG. 1A shows one embodiment of a system 100 for facilitating and/or processing financial transactions. As shown in FIG. 1A, the system 100 includes a customer 110 that provides a form of monetary payment in exchange for a product and/or service, a merchant 120 that provides a product and/or service in exchange for monetary payment from the customer 110, and a transaction service provider 130 that processes the transaction between the customer 110 and the merchant 120. It should be appreciated that the merchant 120 may comprise a plurality of merchants with each having a transaction device.

In one embodiment, the customer 110 establishes a customer account 114 with the transaction service provider 130, wherein the customer 110 may deposit monetary funds in the customer account 114. The transaction service provider 130 issues the customer 110 some form of account information (e.g., account number and password) that is linked to the customer account 114. The customer 110 may use the account information to purchase items (e.g., goods, products and/or services) from the merchant 120. For online transactions, the account information allows login and access to the funds in the customer account 114.

Alternately, the transaction service provider 130 may issue the customer 110 some form of payment media, such as an electronic check resource, credit card resource or debit card resource, that is linked to the customer account 114. The customer 110 may use the payment media to purchase items from the merchant 120.

In one implementation, the customer 110 uses the account information to purchase items from the merchant 120. The merchant 120 uses a transaction device 122, such as a point-of-sale (POS) device, to request processing of the transaction between the customer 110 and the merchant 120 from the transaction service provider 130. For online transactions, the POS device may comprise a computer or server. A processing component 132 of the transaction service provider 130 communicates with a clearing house 140 to debit the customer account 114 according to an amount specific in the payment and credit therewith a merchant account 124 linked to the merchant 120.

In one embodiment, the clearing house 140 resolves financial transactions through validation, delivery and settlement. As such, the clearing house 140 may comprise an agency or institution having a system for settling indebtedness between members of that system through which accounts may be debited and/or credited of monetary funds.

In one embodiment, the merchant 120 may establish the merchant account 124 with any type of financial institution, such as a bank. However, in another embodiment, as shown in FIG. 1B, the merchant 120 may establish the merchant account 122 with the transaction service provider 130. As such, the merchant 120 may need to provide business information to the transaction service provider 130, such as business name, address, phone number, etc., and financial information, such as banking information, merchant account information, credit card information, payment processing information, etc.

In one implementation, the transaction service provider 130 may directly debit the customer account 114 and directly credit the merchant account 124 because both of the accounts 114, 124 are established with the transaction service provider 130. Optionally, in another implementation, the transaction service provider 130 may still process the transaction through the clearing house even though both of the accounts 114, 124 are established with the transaction service provider 130.

In one embodiment, the transaction device 122 is utilized by the merchant 120 to accept payment from the customer 110. The transaction device 122 comprises some form of payment device, such as, for example, a POS terminal, a cash register, a personal computer, etc. The transaction device 122 may comprise one or more functional components including a reader component, an input component, a processor component, a transceiver component, and an output component. The reader and input components may comprise a check reader, credit card reader, debit card reader, keyboard for manual input of account information, or some combination thereof for the purpose of acquiring transaction information from the customer 110 at the point of sale. Once acquired, the transaction information may be transferred from the transaction device 122 of the merchant 120 to the processing component 132 of the transaction service provider 130 for processing.

In one implementation, the transaction may take place over a network, such as the Internet. The transaction may involve an interface device, such as a computer, that is adapted to allow the customer 110 to communicate with the merchant 120 and the transaction service provider 130 via the network. The transaction device 122 of the merchant 120 may include a server that is adapted to communicate with the customer 110 to allow viewing and purchase of items via the network and further communicate with the transaction service provider 130 to process financial transactions via the network. Similarly, the processing component 132 of the transaction service provider 130 may include a server that is adapted to communicate with the customer 110, the merchant 120 and the clearing house 140 to process and resolve financial transactions via the network.

In one embodiment, the network may be implemented as a single network or a combination of multiple networks. For example, in various embodiments, the network may include the Internet, one or more intranets, landline networks, wireless networks, and/or some other appropriate type of communication network. In another example, the network may comprise a wireless telecommunications network (e.g., cellular phone network) adapted to communicate with other communication networks, such as the Internet.

In one embodiment, the customer 110 may use an interface device, such as a personal computer or cell phone device, to communicate with the merchant and/or access the customer account 114 via any appropriate combination of hardware and/or software configured for wired and/or wireless communication over the network. The customer 110 may use a browser application to browse information available over the network. For example, the customer may use a web browser to view information available over the Internet.

In one embodiment, the customer 110 may be asked to provide identification information to the merchant 120 for transaction processing. For example, the identification information provided by the customer 110 may include personal information (e.g., a user name, password, photograph image, biometric id, address, phone number, etc.) and banking information (e.g., banking institution, credit card issuer, user account numbers, security information, etc.). In various implementations, identification information provided by the customer 110 may be passed with a purchase request to the processing component 132 of the transaction service provider 130 to associate the customer 110 with the customer account 114 maintained by the transaction service provider 130.

In one embodiment, the merchant 120 may maintain one or more merchant servers on the network for offering various items for purchase in exchange for payment to be received from the customer 110 over the network. In this regard, each of the one or more merchant servers may include a database for identifying available items, which may be made available to the customer 110 for viewing and purchase. Each of the merchant servers may include some form of a marketplace application configured to provide information over the network to the browser application used by the customer 110. For example, the customer 110 may interact with the marketplace application through the browser application over the network to search and view various items for purchase identified in the database. Each of the one or more merchant servers may include some form of checkout application configured to facilitate online purchase transactions by the customer 110 for items identified by the marketplace application. In this regard, the checkout application may be configured to accept payment information from the customer 110 over the network.

In one embodiment, the merchant 120 may need to provide identification information to be included as part of the transaction request. The identification information may include business and banking information. In various implementations, the identification information provided by the merchant 120 may be passed with the transaction request to the processing component 132 of the transaction service provider 130 to process the transaction, and the identification information provided by the merchant 120 may be used by the processing component 132 to associate the transaction with the merchant account 124.

In one embodiment, the transaction service provider 130 provides transaction processing for point-of-sale or online purchases on behalf of the customer 110 and the merchant 120. In this regard, the transaction service provider 130 may use some form of payment application configured to interact with the customer 110 and the merchant 120 to facilitate the purchase of items. In one example, the transaction service provider 130 may be provided by PayPal, Inc. of San Jose, Calif., USA.

In one embodiment, the transaction service provider 130 may be configured to maintain a plurality of customer and merchant accounts 114, 124, each of which may include account information associated with customers and merchants. For example, account information may include private financial information of the customer 110 and merchant 120, such as one or more account numbers, passwords, credit card information, banking information, or other types of financial information, which may be used to facilitate transactions between the customer 110 and the merchant 120.

In one embodiment, referring to FIG. 1C, the transaction service provider 130 tracks the spending of the customer 110 over a specified period of time and allows the customer 110 to transfer money from another (second) customer account 116 into the (first) customer account 114 to maintain a balance in the (first) customer account 114 for the specified period of time. This allows the customer 110 to earn a high rate of return by purchasing items from the (first) customer account 114 during the specified period of time while maintaining a specified balance in the (first) customer account 114 for specified period of time. In various implementations, the specified period of time may comprise a day, week, month, year or any other desirable period of time without departing form the scope of the present disclosure. It should be appreciated that the customer 110 may establish the (second) customer account 116 with any type of financial institution, such as a bank, or the customer may establish the (second) customer account 116 with the transaction service provider 130.

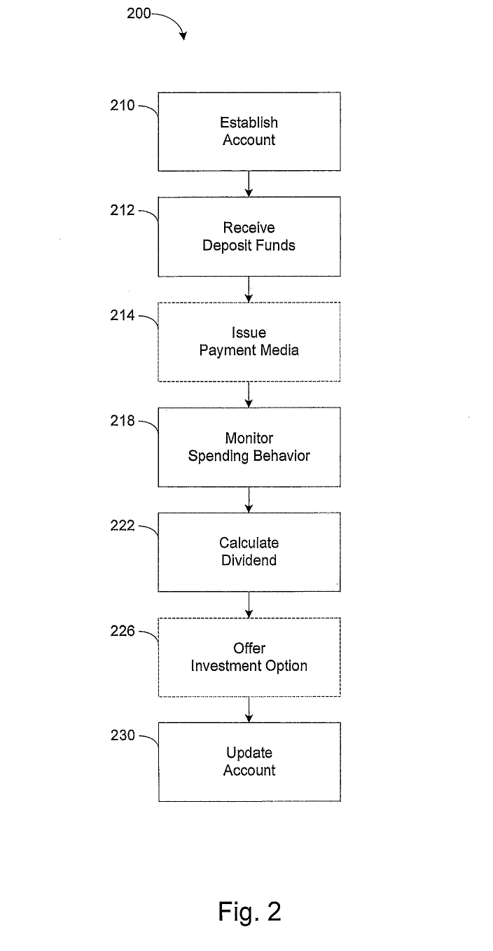

FIG. 2 shows one embodiment of a method 200 for providing variable incentives to a customer based on spending behavior. For purposes of explanation, the method 200 is discussed in reference to FIGS. 1A-1C, but should be limited thereto.

In one implementation, the transaction service provider 130 establishes a customer account 114 with the customer 110 (block 210). The transaction service provider 130 receives monetary funds from the customer 110 for deposit in the established customer account 114 (block 212). Optionally, the transaction service provider 130 may issue some form of payment media to the customer 110 (block 214). For example, the payment media may comprise a debit card resource having an account number and expiration date associated with the customer account 114. Accordingly, since the customer 110 has the ability to purchase items from the merchant 120, the transaction service provider 130 has the ability to monitor the spending behavior of the customer 110 (block 218) when the customer 110 uses the account information related to the customer account 114. Over a specified period of time, the transaction service provider 130 calculates dividends (i.e., rewards) based on the spending behavior of the customer 110 (block 222). Optionally, the transaction service provider 130 offers the customer 110 investments options for monetary funds deposited in the customer account 114 (block 226). For example, the transaction service provider 130 may allow the customer 110 to deposit funds from the customer account 114 to a money market fund to earn interest. Next, the transaction service provider 130 updates the customer account 114 (block 230) to reflect any changes made thereto, such as, for example, posting dividends or interest from a money market fund.

In one implementation example, referring to the method 200 of FIG. 2, the transaction service provider 130 provides account information related to the customer account 114 to the customer 110. The transaction service provider 130 applies a dividend, such as 0.5%, to the funds spent from the customer account 110. For example, the customer 110 may earn up to 0.5% cash back on items purchased from the customer account 114. Optionally, if the customer transfers monetary funds into the customer account 114 to pay for the items purchased, then the customer 110 may opt to invest the deposited funds in a money market fund to earn an interest rate of, for example, 5% annual percentage yield (APY).

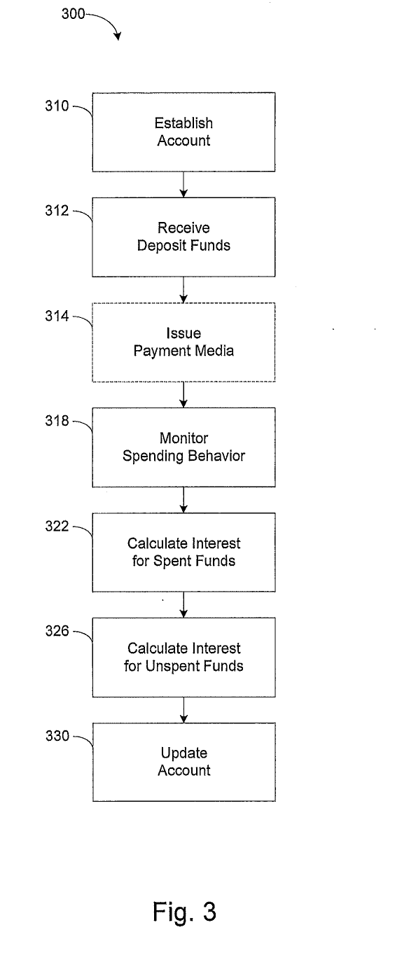

FIG. 3 shows one embodiment of a method 300 for providing variable incentives to a customer based on spending behavior. For purposes of explanation, the method 300 is discussed in reference to FIGS. 1A-1C, but should be limited thereto.

In one implementation, the transaction service provider 130 establishes a customer account 114 with the customer 110 (block 310). The transaction service provider 130 receives monetary funds from the customer 110 for deposit in the established customer account 114 (block 312). Optionally, the transaction service provider 130 may issue some form of payment media to the customer 110 (block 314). The transaction service provider 130 has the ability to monitor the spending behavior of the customer 110 (block 218). Over a specified period of time, the transaction service provider 130 calculates interest for spent funds based on the spending behavior of the customer 110 (block 322). Similarly, over the specified period of time, the transaction service provider 130 calculates interest for unspent funds based on the spending behavior of the customer 110 (block 326). For example, the rate of return (i.e., interest rate) for monetary funds deposited in the customer account 114 may comprise a first value, such as 6%, for funds spent during the specified period of time, and a second value, such as 4%, for unspent funds during the specified period of time. Next, the transaction service provider 130 updates the customer account 114 to reflect any changes made thereto, such as, for example, posting interest (block 330).

In one implementation example, referring to the method 300 of FIG. 3, the transaction service provider 130 establishes the customer account 114 with the customer 110. As such, the transaction service provider 130 may apply a first rate of return to an amount of monetary funds spent during the specified period of time and a second rate of return to an amount of monetary funds not spent during the same specified period of time. For instance, the customer 110 may opt to invest monetary funds from the customer account 114 to a money market fund or an FDIC insured checking account and earn 6% APY (i.e., the first rate of return) on monetary funds spent on purchases and earn 4% APY (i.e., the second rate of return) on monetary funds not spent on purchases during the course of a month (i.e., the specified period of time). It should be appreciated that the specified period of time may comprise any desirable period of time (e.g., hour, day, week, bi-month, month, semi-annual, annual, etc.) without departing form the scope of the present disclosure.

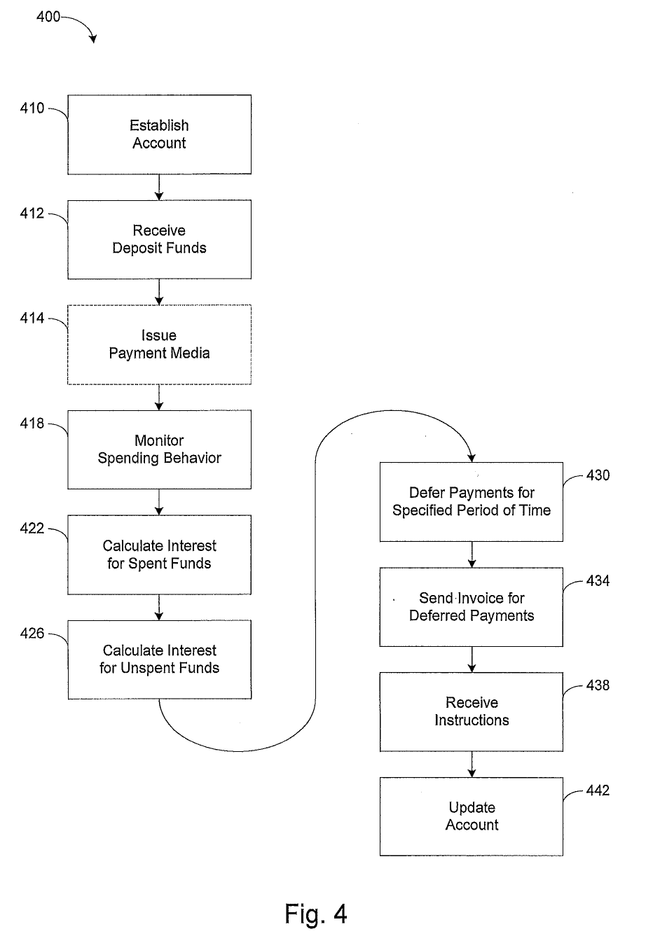

FIG. 4 shows one embodiment of a method 400 for providing variable incentives to a customer based on spending behavior. For purposes of explanation, the method 400 is discussed in reference to FIGS. 1A-1C, but should be limited thereto.

In one implementation, the transaction service provider 130 establishes a customer account 114 with the customer 110 (block 410). The transaction service provider 130 receives monetary funds from the customer 110 for deposit in the established customer account 114 (block 412). Optionally, the transaction service provider 130 may issue some form of payment media to the customer 110 (block 414). The customer 110 has the ability to purchase items from the merchant 120. Accordingly, the transaction service provider 130 has the ability to monitor the spending behavior of the customer 110 (block 418). Over a specified period of time, the transaction service provider 130 calculates interest for spent funds based on the spending behavior of the customer 110 (block 422). Similarly, over the specified period of time, the transaction service provider 130 calculates interest for unspent funds based on the spending behavior of the customer 110 (block 426).

Next, the transaction service provider 130 defers payments for purchases made during the specified period of time (block 430). The transaction service provider 130 sends the customer 110 an invoice for the deferred payments (block 434). The transaction service provider 130 receives instructions from the customer 110 for resolution of the deferred payments (block 438). For example, instructions from the customer 110 may include depositing monetary funds into the customer account 114 to cover the invoice amount, or instructions may include paying for the deferred payments from the monetary funds currently in the customer account 114, which gives the customer 110 options on how to pay for purchases and the opportunity to earn a higher rate of return. Next, the transaction service provider 130 updates the customer account 114 to reflect any changes made thereto, such as, for example, posting interest (block 442).

In one implementation example, referring to the method 400 of FIG. 4, the transaction service provider 130 allows the customer 110 to make purchases with funds in the customer account 114. The monetary funds are deposited in an FDIC insured checking account, wherein the transaction service provider 130 applies a first rate of return to an amount of monetary funds spent during the specified period of time and a second rate of return to an amount of monetary funds not spent during the same specified period of time. For instance, the customer 110 opts to deposit monetary funds from the customer account 114 to an FDIC insured checking account and earn 6% APY (i.e., the first rate of return) on monetary funds spent on purchases and earn 4% APY (i.e., the second rate of return) on monetary funds not spent on purchases during the course of a month (i.e., the specified period of time). The transaction service provider 130 defers payments for purchases until the following month, wherein at that time, the transaction service provider 130 sends an invoice to the customer 110 asking whether the customer 100 wants to use the monetary funds currently in the customer account 114 or transfer monetary funds from another account.

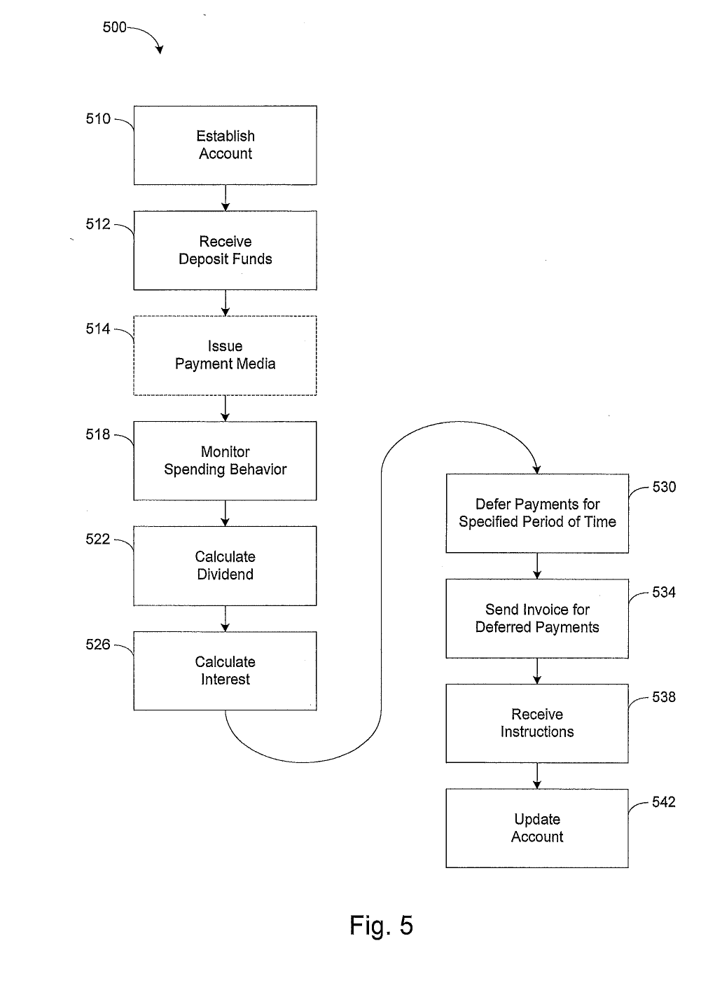

FIG. 5 shows one embodiment of a method 500 for providing variable incentives to a customer based on spending behavior. For purposes of explanation, the method 500 is discussed in reference to FIGS. 1A-1C, but should be limited thereto.

In one implementation, the transaction service provider 130 establishes a customer account 114 with the customer 110 (block 510). The transaction service provider 130 receives monetary funds from the customer 110 for deposit in the established customer account 114 (block 512). Optionally, the transaction service provider 130 may issue some form of payment media to the customer 110 (block 514). The customer 110 has the ability to purchase items from the merchant 120, and the transaction service provider 130 has the ability to monitor the spending behavior of the customer 110 (block 518). Over a specified period of time, the transaction service provider 130 calculates dividends (i.e., rewards) based on the spending behavior of the customer 110 (block 522). For example, the transaction service provider 130 applies a dividend, such as 0.5%, to the funds spent from the customer account 110. Next, the transaction service provider 130 calculates interest for deposited funds (block 526) over the specified period of time. For example, the transaction service provider 130 may allow the customer 110 to deposit funds from the customer account 114 to a money market fund to earn interest, such as, for example, 4% APY.

Next, the transaction service provider 130 defers payments for purchases made during the specified period of time (block 530). The transaction service provider 130 sends the customer 110 an invoice for the deferred payments (block 534). The transaction service provider 130 receives instructions from the customer 110 for resolution of the deferred payments (block 438). For example, instructions from the customer 110 may include depositing monetary funds into the customer account 114 to cover the invoice amount, or instructions may include paying for the deferred payments from the monetary funds currently in the customer account 114, which gives the customer 110 options on how to pay for purchases and the opportunity to earn a higher rate of return. Next, the transaction service provider 130 updates the customer account 114 to reflect any changes made thereto, such as, for example, posting interest (block 542).

In one implementation example, referring to the method 500 of FIG. 5, the customer 110 may opt to earn no interest on the deposited monetary funds, or the customer 110 may opt to invest the deposited funds in a money market fund to earn an interest rate of, for example, 4% annual percentage yield (APY). The transaction service provider 130 applies a dividend, such as 0.5%, to the funds spent from the customer account 110. For example, the customer 110 may earn up to 0.5% cash back on items purchased from the customer account 114. The transaction service provider 130 defers payments for purchases until the following month, wherein at that time, the transaction service provider 130 sends an invoice to the customer 110 asking whether the customer 100 wants to use the monetary funds currently in the customer account 114 or transfer monetary funds from another account.

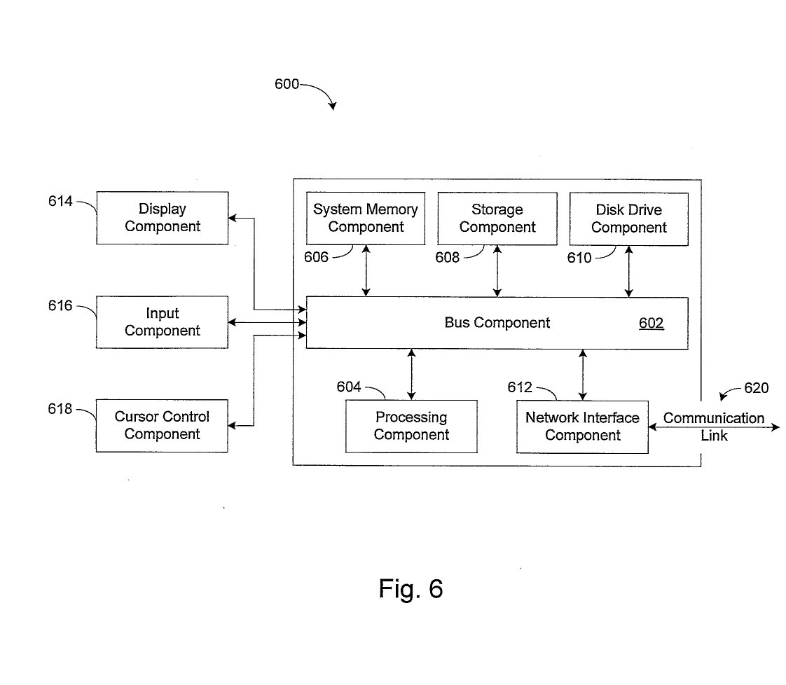

FIG. 6 shows a block diagram of a computer system 600 suitable for implementing embodiments of the present disclosure. Computer system 600 includes a bus 602 or other communication mechanism for communicating information, which interconnects subsystems and components, such as processing component 604 (e.g., processor, micro-processor, micro-controller, digital signal processing (DSP) device), system memory component 606 (e.g., RAM), static storage component 608 (e.g., ROM), disk drive component 610 (e.g., magnetic or optical), network interface component 612 (e.g., modem, Ethernet card, wireless transceiver), display component 614 (e.g., CRT or LCD), input component 616 (e.g., keyboard), and cursor control component 618 (e.g., mouse or trackball).

In accordance with embodiments of the invention, computer system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of or in combination with software instructions to implement the invention.

Logic may be encoded in a computer readable medium, which may refer to any medium that participates in providing instructions to processor 604 for execution. Such a medium may take many forms, including but not limited to, non-volatile media, volatile media, and transmission media. In various implementations, non-volatile media includes optical or magnetic disks, such as disk drive component 610, volatile media includes dynamic memory, such as system memory component 606, and transmission media includes coaxial cables, copper wire, and fiber optics, including wires that comprise bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the invention, execution of instruction sequences to practice the invention may be performed by computer system 600. In various other embodiments of the invention, a plurality of computer systems 600 coupled by communication link 620 (e.g., LAN, wireless LAN, wireless network) may perform instruction sequences to practice the invention in coordination with one another.

Computer system 600 may transmit and receive messages, data, information and instructions, including one or more programs (i.e., application code) through communication link 620 and network interface component 612. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus, the invention is limited only by the claims.

What is claimed is:

1. A system for providing incentives to a customer based on spending behavior, the system comprising:
a customer account established with the customer for depositing funds,
wherein a first rate of return is applied to the deposited funds in the customer account based on the amount of funds spent from the customer account, and
wherein a second rate of return is applied to funds in the customer account based on the amount of funds not spent from the customer account.

2. The system claim 1, wherein the system comprises a transaction service provider adapted to establish the customer account with the customer and monitor the spending behavior of the customer in reference to the customer account.

3. The system claim 1, wherein the deposited funds comprise monetary funds that are used to purchase the one or more items from a merchant.

4. The system claim 1, wherein the customer account comprises a checking account.

5. The system claim 1, wherein the first and second rates of return comprise an interest rate with an annual percentage yield (APY).

6. The system claim 1, wherein the first rate of return is at least greater than the second rate of return.

7. The system claim 1, further comprising a storage component adapted to store a plurality of accounts including the customer account related to the customer, wherein the customer account includes customer information related to the customer, and wherein the customer information is passed with each purchase.

8. The system of claim 1, wherein at least one merchant provides one or more items for purchase to the customer, and wherein the at least one merchant comprises a transaction device that allows the customer to purchase the one or more items.

9. The system of claim 8, wherein the one or more items for purchase include at least one of goods, products and services.

10. A system for providing incentives to a customer based on one or more financial transactions between the customer and at least one merchant, the system comprising:
a transaction service provider adapted to establish a customer account with the customer for depositing funds,
wherein the transaction service provider applies a first rate of return to funds in the customer account based on the amount of funds spent from the customer account, and
wherein the transaction service provider applies a second rate of return to funds in the customer account based on the amount of funds not spent from the customer account.

11. The system claim 10, wherein the transaction service provider is adapted to monitor the spending behavior of the customer in reference to the customer account.

12. The system claim 10, wherein the customer account comprises a checking account.

13. The system claim 10, wherein the first rate of return is at least greater than the second rate of return, and wherein the first and second rates of return comprise an interest rate with an annual percentage yield (APY).

14. The system claim 10, wherein the transaction service provider comprise a storage component adapted to store a plurality of accounts including the customer account related to the customer, wherein the customer account includes customer information related to the customer, and wherein the customer information is passed with each purchase.

15. The system of claim 10, wherein the merchant comprises a transaction device that allows the customer to purchase the one or more items, and wherein the one or more items for purchase include at least one of goods, products and services.

16. A method comprising:
establishing a customer account with a customer for depositing funds;
monitoring the spending behavior of the customer;
applying a first rate of return to the deposited funds based on the amount of funds spent from the customer account; and
applying a second rate of return to the deposited funds based on the amount of funds not spent from the customer account.

17. The method of claim 16, further comprising processing financial transactions between the customer and at least one merchant.

18. The system claim 16, wherein the customer account comprises a checking account.

19. The system claim 16, wherein the first rate of return is at least greater than the second rate of return, and wherein the first and second rates of return comprise an interest rate with an annual percentage yield (APY).

20. The method of claim 16, further comprising maintaining a plurality of accounts including the customer account and a merchant account related to the merchant, wherein the customer account includes financial information related to the customer, and wherein the merchant account includes financial information related to the merchant.
